(19) United States
(12) Patent Application Publication
(10) Pub. No.: US 2010/0224330 A1
(43) Pub. Date: Sep. 9, 2010

(54) SAFETY DEVICE FOR QUICKLY RELEASING CONTROL ROPES OF ROMAN SHADES

(76) Inventors: Wen Ying Liang, Fuxing Shiang (TW); Sheng Ying Hsu, Fuxing Shiang (TW)

Correspondence Address: PHILLIP LIU, 6980, WHITEOAK DRIVE, RICHMOND, V7E4Z9, omitted

(21) Appl. No.: 12/414,550

(22) Filed: Mar. 30, 2009

(30) Foreign Application Priority Data
Mar. 6, 2009 (TW) 098203393

(51) Int. Cl. E06B 9/24; A47H 1/00

(52) U.S. Cl. 160/84.04; 160/332

(57) ABSTRACT

A safety device for Roman shades includes multiple loop members connected to the shade and multiple restriction members are connected to multiple loop members. Each restriction member includes two extensions which spirally wrap to each other so as to define an opening therebetween. Multiple engaging members are connected to the lowest loop members and each engaging member has two claws between which a through hole is defined. Each claw includes a slit defined axially in a distal end thereof. Multiple control ropes each have a top end connected to the top box and the lower end of each control rope extends through the openings of the restriction members and is connected to an insertion member which is inserted into the silts and engaged with the through hole of the engaging member corresponding thereto. When the control ropes are pulled laterally, the insertion members are disengaged from the engaging members.

### FIELD OF THE INVENTION

The present invention relates to a Roman shade, and more particularly, to a safety device for quickly releasing the control ropes of Roman shade when the control ropes are pulled abnormally.

### BACKGROUND OF THE INVENTION

A conventional Roman shade includes a shade which generally is a fabric sheet and the fabric sheet has one end fixed to the top box and a lot of folded portions are formed on the inside and/or outside of the shade so as to establish specific decoration features. A lot of passages are defined transversely through the shade and rods extend through the passage to define sections of the shade. Multiple rings are fixedly connected to the folding lines of the shade. Two control ropes each have a first end connected to a control mechanism in the top box and the other end of each control rope extends through the rings and is fixed to the lowest rings. The user can lift and lower the shade by pull of the control ropes.

When pulling the control ropes, the lowest rings are lifted and the sections of the shade are collected upward one by one by the pulling force applied to the rings. However, the control ropes are exposed and children may play the control ropes and this can be dangerous when the control ropes tangle the kids. The control ropes tangle the kids tightly when the kids struggle.

The present invention intends to provide a safety device for Roman shades and which includes multiple engaging members connected to the lower end of the shade. When the control ropes are pulled laterally, the control ropes are easily disengaged from the engaging members and do not tangle the children.

### SUMMARY OF THE INVENTION

The present invention relates to Roman shade which comprises a top box and the top end of the fabric sheet of the shade is connected to the top box and multiple pocket portions are formed along a first side of the shade. The pocket portions each are defined by folding upward a part of the fabric sheet and then fixed the part along a folding line. Multiple loop members are connected to each of the folding lines. Multiple restriction members are connected to the multiple loop members. The loop members located at the lower end of the sheet each are connected with an engaging member and each engaging member includes two claws extending therefrom in the same direction. A through hole is defined between the two claws and an opening is located between the two claws and communicates with the through hole. Each claw includes a slit defined axially in a distal end thereof. Two control ropes each have a first end connected to the top box and a second end of each of the two control ropes extends through the loop members. Two insertion members are connected to the two respective second ends of the two control ropes and inserted into the slits of the two claws via the openings and engaged with the through holes. The claws clamp the insertion members to position the insertion members between the two claws. When the control ropes are pulled beyond a clamping force applied to the insertion members, the insertion members are disengaged from the slits and the through holes of the two claws.

The primary object of the present invention is to provide a safety device for Roman shades wherein the control ropes can be easily loosen from the shade when they are pulled laterally so as to prevent children from playing and being tangled.

Another object of the present invention is to provide a safety device for Roman shades wherein the restriction members of the safety device can be made of metal or plastic material. The restriction members can be manufactured easily at low cost.

Yet another object of the present invention is to provide a safety device for Roman shades wherein the restriction members of the safety device includes two extensions and a gap is defined between the two extensions, so that the control rope can be escaped from the gap.

A further object of the present invention is to provide a safety device for Roman shades wherein the engagement of the insertion members and the engaging members can be used to the scroll-type shade and the control ropes can be escaped when the control ropes are pulled abnormally.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the Roman shade with the safety device of the present invention;

FIG. 2 is an enlarged view to show that the control rope extends through the restriction hole of the restriction member of the safety device of the present invention;

FIG. 3 is an exploded view to show the engaging member and the insertion member connected to the control rope of the safety device of the present invention;

FIG. 4 is an enlarged view to show that the insertion member on the control rope is engaged with the engaging member of the safety device of the present invention;

FIG. 5 shows that the lower portion of the Roman shade is pulled upward;

FIG. 6 is an enlarged view to show that two restriction members are collected together when the lower portion of the Roman shade is pulled upward, and the insertion member is still engaged with the engaging member;

FIG. 7 shows that the lower portion of the Roman shade is pulled upward, while the insertion members are engaged with the engaging members;

FIG. 8 shows that the insertion members on the control rope is disengaged form the engaging member when the control ropes are pulled laterally, and

FIG. 9 shows the safety device of the present invention is used with a scroll-type shade.

### DETAILED DESCRIPTION OF THE PREFERRED EMBODIMENT

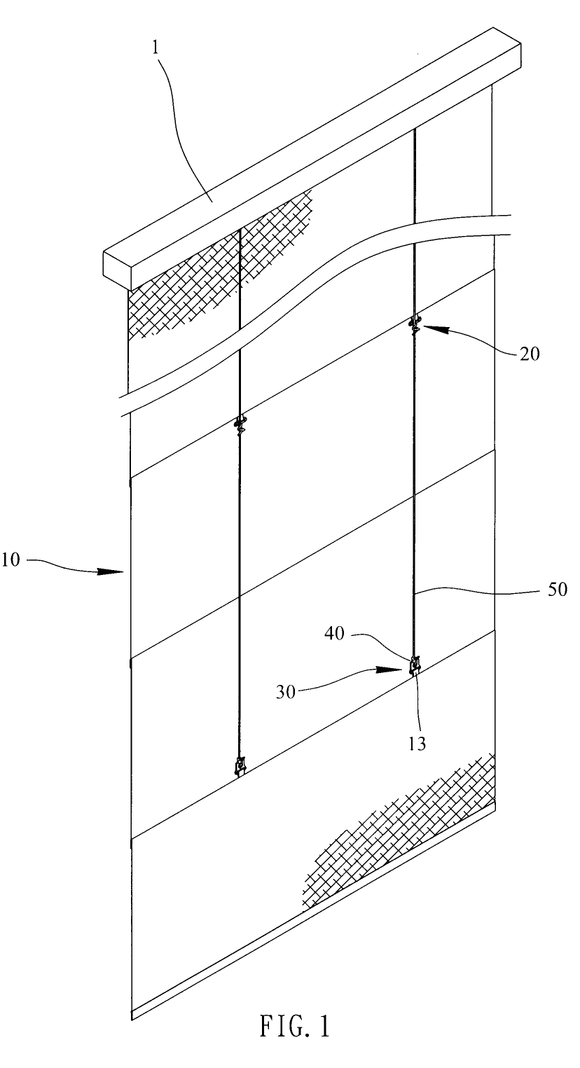

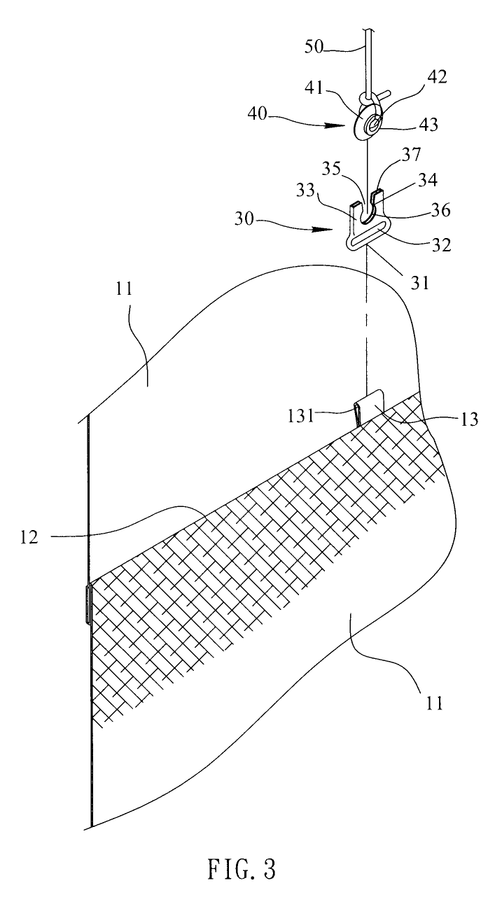

Referring to FIGS. 1 to 4, the Roman shade of the present invention comprises a top box 1 in which control mechanism (not shown) is received and the control mechanism is known to persons in the art and will not be described in detail. A shade 10 may include a single fabric sheet or composed of multiple fabric sheets 11. The top end of the shade 10 is connected to the top box 1 and multiple pocket portions are formed along a first side of the shade 10. The pocket portions each are defined by folding upward a part of the fabric sheet 11 and then fixing the part along a folding line 12. Each pocket portion defines a passage which extends transversely through the shade 10. Rods extend through the passages to form multiple sections of the shade 10. Multiple loop members 13 are connected to each of the folding lines 12.

Multiple restriction members 20 are connected to the multiple loop members 13 except for the loop members 13 located at the lower portion of the shade 10. Each restriction member 20 includes a ring 21 which includes a first elongate slot 22. Each of the loop members 13 includes a hole 131 so that the ring 21 of the restriction members 20 extends through the hole 131 an the loop member 13 goes through the first elongate slot 22. Each restriction member 20 includes the ring 21, a bent first extension 23 and a bent second extension 24. The bent first extension 23 and the bent second extension 24 have a conjunction end which is fixed to the ring 21 and the first and second bent extensions 23, 24 extend across each other to define a restriction hole 25. A gap is defined between the first and second extensions 23, 24, and the gap communicates with the restriction hole 25. The first bent distal end 231 of the first bent extension 23 and the second bent distal end 241 of the second bent extension 24 extend laterally.

Each of the loop members 13 connected to the lower end of the shade 10 is connected with an engaging member 30 and each of the engaging members 30 includes a connection portion 31 which includes a second elongate slot 32. The loop member 13 is connected to the connection portion 31 by extending through the second elongate slot 32. The connection portion 31 of each engaging member 30 is connected to the loop members 13 by extending the through holes 131.

Each engaging member 30 includes two claws 33 extending therefrom in the same direction. A through hole 36 is defined between the two claws 33 and an opening 35 is located between the two claws 33 and communicates with the through hole 36. Each of the two claws 33 of each of the engaging members 30 includes a stop 34 extending inward from an inside thereof. The opening 35 is defined between the two stops 34 and the through hole 36 is defined between the insides of the two claws 33 and the stops 34. Each claw 33 includes a slit 37 defined axially in a distal end thereof and the stop 34 connected to the claw 33. The engaging members 30 can be made of plastic material or metallic material.

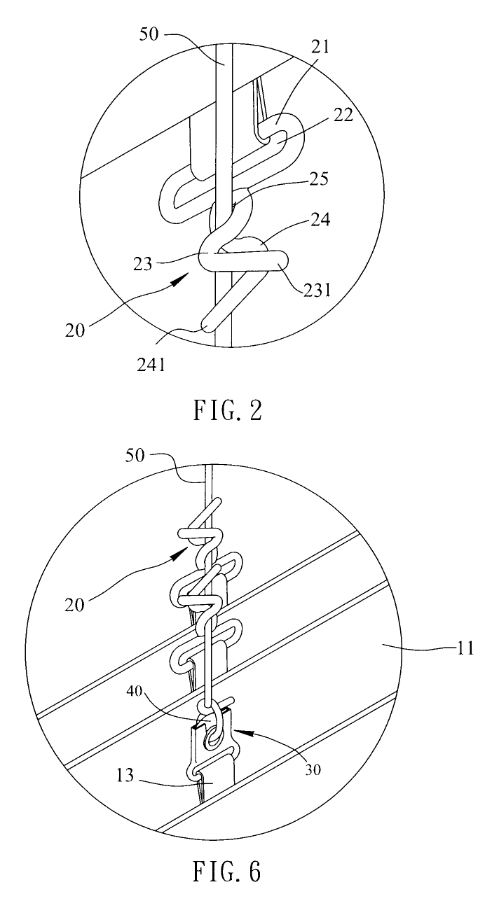

Two control ropes 50 each have a first end connected to the top box 1 and a second end of each of the two control ropes 50 extend through the restriction hole 25 of the loop member 20 corresponding thereto as shown in FIG. 2.

Two insertion members 40 are connected to the two respective second ends of the two control ropes 50 and each of the insertion members 40 is a ring-shaped member and includes a ramp portion 41 on two sides thereof and a passage 42 is defined through each of the insertion members 40. An annular lip 43 extends from a periphery of the passage 42. The second end of the control rope 50 ties to passage 42 of the insertion member 40.

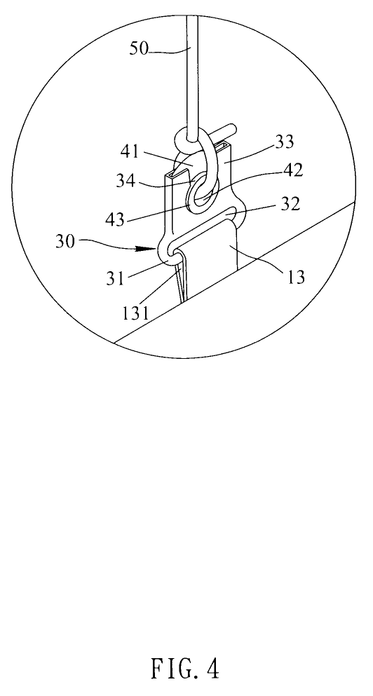

As shown in FIG. 4, the insertion members 40 each are inserted into the slits 37 of the two claws 33 via the openings 35 and engaged with the through holes 36. The annular lip 43 is engaged with the periphery of the passage 42. The claws 33 clamp the insertion members 40 to position the insertion members 40 between the two claws 33.

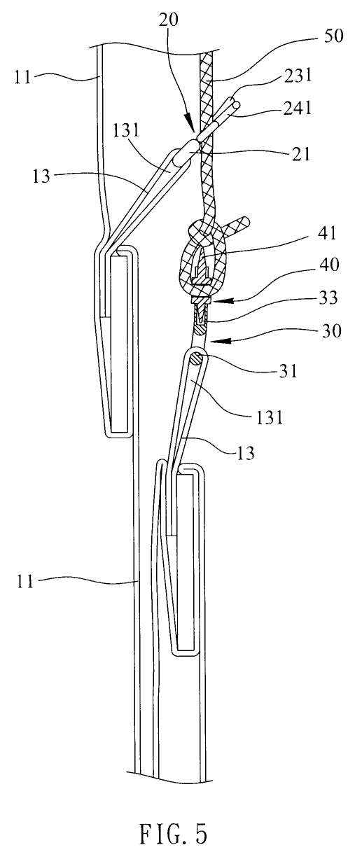

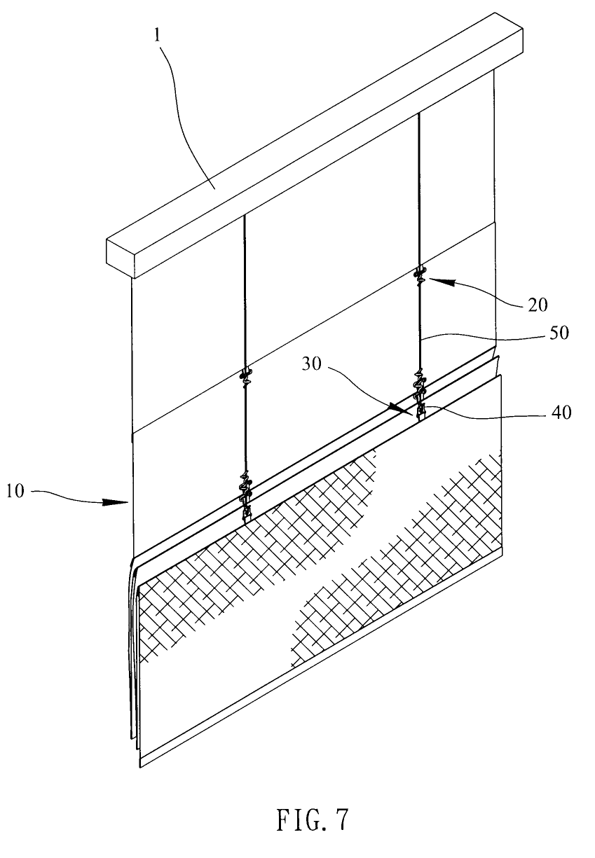

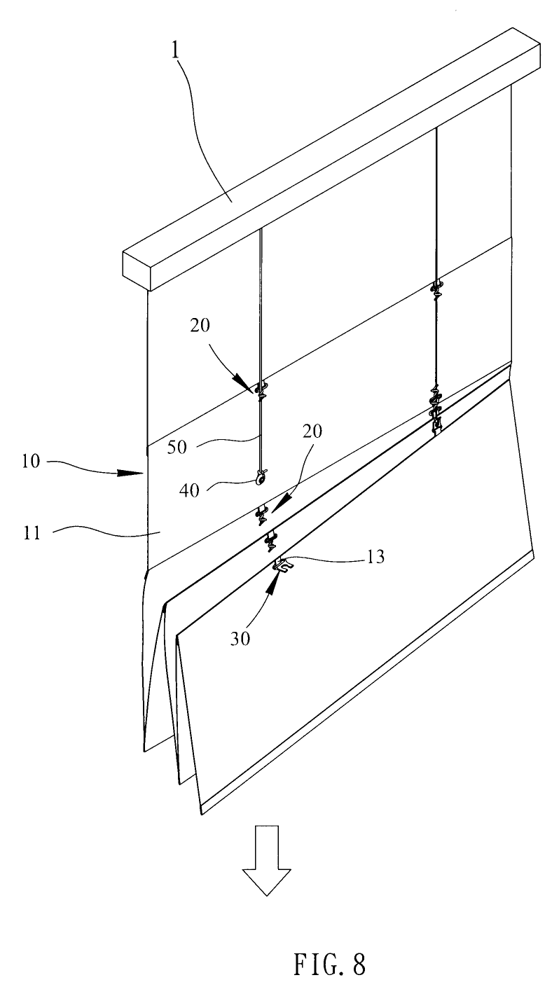

As shown in FIGS. 5 to 7, when pulling the control ropes 50 normally, the insertion members 40 drag the engaging members 30 and the shade 10 is collected from the lower end one section by one section. The control ropes 50 freely move through the restriction holes 25 of the restriction members 20.

As shown in FIG. 8, when the control ropes 50 are mis-operated, such as are pulled laterally rather than pulled up and down, or when the control ropes 50 tangle the children who try to struggle to escape from the control ropes 50 and drag the control ropes 50 with significant force, the significant force separates the insertion members 40 from the engaging members 30. The control ropes 50 can also easily disengaged from the restriction holes 25 and the gaps between the first and second bent distal ends 231, 241 of the restriction members 20. When the insertion members 40 are dragged upward, the annular kip 43 push the stops 37 and the two claws 33 outward to assist the disengagement of the insertion members 40 from the engaging members 30. Of course, the insertion members 40 can be any shape such as polygonal insertion members 40. Each of the insertion members 40 can be made of plastic material.

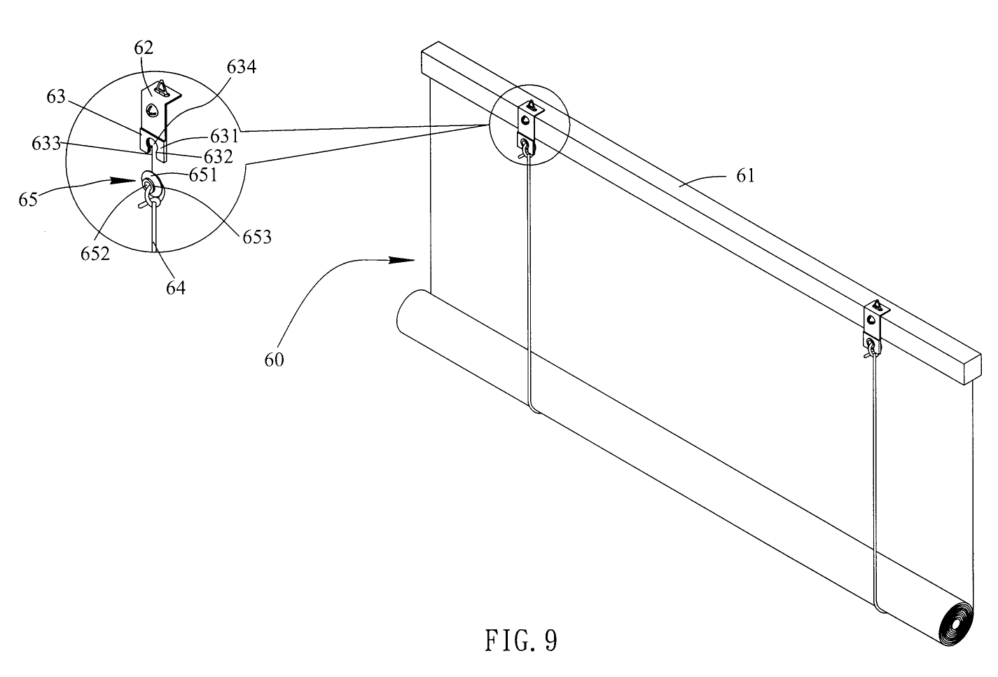

As shown in FIG. 9, the safety device of the present invention can be used with a scroll-type shade 60 which includes a top box 61, a shade 60 has a top end connected to the top box 61 and multiple restriction members 62 are connected to the top box 61. Each restriction member 62 is connected to an engaging member 63 which has two claws 631 extending therefrom in the same direction. A through hole 634 is defined between the two claws 631 and an opening 633 is located between the two claws 631 and communicates with the through hole 634. Each of the two claws 631 of each of the engaging members 63 includes a stop 632 extending inward from an inside thereof. The opening 633 is defined between the two stops 632 and the through hole 634 is defined between the insides of the two claws 631 and the stops 632. A slit is defined in the distal end of each claw 631 and the stop 632 of each of the claws 631.

Two control ropes 64 each have a first end connected to a lower end of the shade 60 and a second end of each of the two control ropes 64 are connected to an insertion member 65 which is inserted into the opening 633 and engaged with the through hole 634 of the engaging member 63 corresponding to the control rope 64. Each of the insertion members 65 is a ring-shaped member and includes a ramp portion 651 on two sides thereof and a passage 652 is defined through each of the insertion members 65. An annular lip 653 extends from a periphery of the passage 652.

When the control ropes 64 are pulled beyond a clamping force applied to the insertion members 65, the insertion members 65 are disengaged from the slits and the through holes 634 of the two claws 63.

While we have shown and described the embodiment in accordance with the present invention, it should be clear to those skilled in the art that further embodiments may be made without departing from the scope of the present invention.

What is claimed is:

1. A Roman shade comprising:
a top box;
a shade composed of a fabric sheet and a top end of the shade connected to the top box and multiple pocket portions formed along a first side of the shade, the pocket portions each being defined by folding upward a part of the fabric sheet and fixing the part along a folding line, each pocket portion defining a passage which extends transversely through the shade, rods extending through the passages, multiple loop members connected to each of the folding lines;
the loop members located at the lower end of the shade each connected with an engaging member and each engaging member including two claws extending therefrom in the same direction, a through hole defined between the two claws and an opening located between the two claws and communicating with the through hole, each claw including a slit defined axially in a distal end thereof;
two control ropes each having a first end connected to the top box and a second end of each of the two control ropes extending through the loop members;
two insertion members connected to the two respective second ends of the two control ropes, the insertion members inserted into the slits of the two claws via the openings and engaged with the through holes, the claws clamping the insertion members to position the insertion members between the two claws, when the control ropes are pulled beyond a clamping force applied to the insertion members, the insertion members are disengaged from the slits and the through holes of the two claws.

2. The Roman shade as claimed in claim 1, wherein each of the engaging members includes a connection portion which has an elongate slot, the elongate slot of the connection portion of each of the engaging members is connected to one of the loop members.

3. The Roman shade as claimed in claim 1, wherein each of the two claws of each of the engaging members includes a stop extending inward from an inside thereof, the opening is defined between the two stops and the through hole is defined between the insides of the two claws and the stops, the slit is defined in the distal end of each claw and the stop of each of the claws.

4. The Roman shade as claimed in claim 1, wherein the engaging members are made of plastic material.

5. The Roman shade as claimed in claim 1, wherein the engaging members are made of metallic material.

6. The Roman shade as claimed in claim 1, wherein each of the insertion members is a ring-shaped member and includes a ramp portion on two sides thereof and a passage is defined through each of the insertion members, an annular lip extends from a periphery of the passage and is engaged with a periphery of the through hole of the engaging member.

7. The Roman shade as claimed in claim 1, wherein each of the insertion members is made of plastic material.

8. The Roman shade as claimed in claim 1, wherein multiple restriction members are connected to the loop members except for the loop members connected with the engaging members, each restriction member including a ring, a bent first extension and a bent second extension are connected to the ring, a gap is defined between the first and second extensions, a restriction hole is defined between the first and second extensions and communicates with the gap, the control rope extends through the restriction hole.

9. The Roman shade as claimed in claim 8, wherein the bent first extension and the bent second extension have a conjunction end which is fixed to the ring and extend across each other to define the restriction hole.

10. A Roman shade comprising:
a top box;
a shade having a top end thereof connected to the top box and multiple restriction members connected to the top box, each restriction member connected to an engaging member which has two claws extending therefrom in the same direction, a through hole defined between the two claws and an opening located between the two claws and communicating with the through hole, each claw includes a slit defined axially in a distal end thereof, and
two control ropes each having a first end connected to the shade and a second end of each of the two control ropes connected to an insertion member which is inserted into the opening and engaged with the through hole of the engaging member corresponding to the control rope, when the control ropes are pulled beyond a clamping force applied to the insertion members, the insertion members are disengaged from the slits and the through holes of the two claws.

11. The Roman shade as claimed in claim 10, wherein each of the two claws of each of the engaging members includes a stop extending inward from an inside thereof, the opening is defined between the two stops and the through hole is defined between the insides of the two claws and the stops, the slit is defined in the distal end of each claw and the stop of each of the claws.

12. The Roman shade as claimed in claim 10, wherein each of the insertion members is a ring-shaped member and includes a ramp portion on two sides thereof and a passage is defined through each of the insertion members, an annular lip extends from a periphery of the passage and is engaged with a periphery of the through hole of the engaging member.
